(19) United States
(12) Patent Application Publication
(10) Pub. No.: US 2024/0021023 A1
(43) Pub. Date: Jan. 18, 2024

(54) System and Method for Touchless and Ticketless Parking

(71) Applicant: ParkEngage Inc., Milpitas, CA (US)

(72) Inventors: Rajiv Jain, Milpitas, CA (US); Joseph Parker, Aliquippa, PA (US)

(21) Appl. No.: 18/369,733

(22) Filed: Sep. 18, 2023

Related U.S. Application Data
(63) Continuation-in-part of application No. 17/734,060, filed on Apr. 30, 2022.
(60) Provisional application No. 62/407,683, filed on Oct. 13, 2016.
(60) Provisional application No. 62/407,693, filed on Oct. 13, 2016.
(60) Provisional application No. 63/182,455, filed on Apr. 30, 2021.

(51) Int. Cl. G07B 15/02; G06Q 50/30

(52) U.S. Cl. CPC G07B 15/02; G06Q 50/30; G06Q 20/3276

(57) ABSTRACT

The application relates generally to systems, apparatus and methods for parking facilities allowing users to be able to seamlessly use the facilities to park their vehicles in a safe and efficient manner. The application also relates to systems and methods for touchless parking. More particularly, the present invention is in the area of allowing parking technology automation while enhancing the safety, convenience and user experience in general.

### RELATED APPLICATIONS

This application is related to the following:
1. Provisional Application Ser. No. 62/407,683, filed Sep. 18, 2022 (Provisional 1);
2. Provisional Application Ser. No. 62/407,693, filed Sep. 18, 2022 (Provisional 2);
3. U.S. Non-Provisional application Ser. No. 17/734,060 filed Apr. 30, 2022 entitled Computer Implemented System and Method for Touchless Parking Entry, Payment, and Exit from Parking Facility, and Computer-Readable Medium Having Processor-Executable Instructions For Same, which is hereby incorporated by reference in entirety.

This application claims priority to the Provisional 1 and Provisional 2, and hereby claims benefit of the filing date of each thereof pursuant to 37 CFR § 1.78(a)(4).

The subject matter of the Provisional 1 and the Provisional 2, each in its entirety, is expressly incorporated herein.

### FIELD OF THE INVENTION

The application relates generally to systems, apparatus and methods for parking facilities allowing users to be able to seamlessly use the facilities to park their vehicles in a safe and efficient manner. The application also relates to systems and methods for touchless parking. More particularly, the present invention is in the area of allowing parking technology automation while enhancing the safety, convenience and user experience in general.

### BACKGROUND OF THE INVENTION

Current parking facilities generally require either an attendant to provide an entry ticket and collect payment from consumers using the facility, provide kiosk type structures where a user can make payment and display a payment receipt on the dashboard, or allow for gate operation through use of a machine where the user takes a ticket and make payment using similar system with credit card or cash on exit.

Some parking systems allow users to have a subscription service and allow for either a card that can be read by a card reader at entrance or provide a tag to be mounted on the vehicle that can operate the gate through sensors.

Traditional systems require the user to either interact with another person, or obtain a ticket or a receipt to complete the transaction. This is especially true for systems which do not have a subscription service with related automation in the form of a tag or card which is always in user's possession or on the user's vehicle.

The traditional systems can often take additional time in entering and exiting the facilities and often involve multiple touch points for a user. The experience can be improved by utilizing almost a ubiquitous device that most consumers now carry on them—their smart phone. The recent COVID pandemic has also resulted in enhanced requirements by users to their safety by having as few touch points as possible.

For reasons stated above and for other reasons which will become apparent to those skilled in the art upon reading and understanding the present specification, there is a need in the art for improved systems and methods for parking facilities and parking structures.

### BRIEF DESCRIPTION OF THE INVENTION

The above-mentioned shortcomings, disadvantages and problems are addressed herein, as will be understood by those skilled in the art upon reading and studying the following specification.

This Summary is provided to introduce a selection of concepts in a simplified form that are further described below in more detail in the Detailed Description. This Summary is not intended to identify key or essential features of the claimed subject matter.

Unless otherwise defined, all terms (including technical and scientific terms) used herein have the same meaning as commonly understood by one of ordinary skill in the art to which this application belongs. It will be further understood that terms, such as those defined in commonly used dictionaries, should be interpreted as having a meaning that is consistent with their meaning in the context of the relevant art and the present application, and will not be interpreted in an idealized or overly formal sense unless expressly so defined herein.

In one aspect, systems, apparatus, and methods are provided through which the above objective of minimizing touches while parking a vehicle and enhancing the user experience, efficiency of the transaction and minimizing the time needed for entry and exit can be achieved.

It will be understood that the terminology used in this application may also encompass terms such as touchless parking, frictionless parking, ticketless parking, mobile parking, mobile payments for parking and other similar terms.

This invention is to enable parking customers to enter, pay for, and exit a parking facility without the need to handle paper tickets, cash, or credit cards, without having to interact with attendants, cashiers, or payment machines, without having to wait in lines with other customers to pay, and in general to be able to park, pay, and exit while preserving social distancing and minimizing the possibility of being exposed to or transmitting germs with other customers or employees of the parking facility.

This invention is an electronic, software system that is designed to operate in a cloud based, Software as a Service (SaaS) model and that customers may access via their smart phone or tablet device with or without the need to install a proprietary mobile application in order to use the service. The system is designed to work with any of the parking operator's gating system through the internet or local area network in order for the system to be able to open the gate to provide customer entry and egress.

All of the end-user functionality that is provided as part of this system can be accessed by any mobile smart device possessing a mobile web browser and having internet access and SMS service. The cloud system provides all of the functionality described below via API call and in this way the end-user functionality may also be accessed through any other application or technology that incorporates the appropriate API calls.

In addition to the customer facing mobile system as described above, the system includes cloud based administrative functionality as well to enable the administrator to monitor customer usage, open and close gates, take customer payment, and manage and report on customer activities remotely without needing to interact face-to-face with the customer.

Apparatus, systems, and methods of varying scope are described herein. These aspects are indicative of various non-limiting ways in which the disclosed subject matter may be utilized, all of which are intended to be within the scope of the disclosed subject matter. In addition to the aspects and advantages described in this summary, further aspects, features, and advantages will become apparent by reference to the associated drawings, detailed description, and claims.

### BRIEF DESCRIPTION OF THE DRAWINGS

The disclosed subject matter itself, as well as further objectives, and advantages thereof, will best be illustrated by reference to the following detailed description of embodiments of the methods and systems read in conjunction with the accompanying drawings, wherein:

FIG. 1 illustrates in a pictorial form, the various mechanisms that may be used for managing the entry, exit and payment for an embodiment of a touchless parking system;

FIG. 2 illustrates in a flow chart form, the process flow at entry for a pay-at-exit parking system;

FIG. 3 illustrates in a flow chart form, the process flow at exit for a pay-at-exit parking system;

FIG. 4 illustrates in a flow chart form, the process flow at entry for a pay-at-entry parking system;

FIG. 5 illustrates in a flow chart form, the process flow at exit for a pay-at-entry parking system;

FIG. 6 illustrates in a flow chart form, the process flow for payment through a web parking system;

FIG. 7 illustrates in a flow chart form, the process flow for retrieving the e-ticket in a touchless parking system;

FIG. 8 illustrates in a flow chart form, the process flow for validating a parking electronic ticket or to apply a promocode to the electronic ticket in a touchless parking system.

FIG. 9 illustrates in a flow chart form, the process flow for retrieving the receipt in a touchless parking system.

### DETAILED DESCRIPTION OF THE INVENTION

In the following detailed description, reference is made to the accompanying drawings which form a part hereof, and in which is shown by way of illustration specific embodiments which may be practiced. These embodiments are described in sufficient detail to enable those skilled in the art to practice the embodiments and disclosure. It is to be understood that other embodiments may be utilized, and that logical, mechanical, electrical, and other changes may be made without departing from the scope of the embodiments and disclosure. It is further to be understood that some of the embodiments refer to use of certain software and application services that may be interchangeable with other similar or even dissimilar applications that may provide the support for the needed functionality. In view of the foregoing, the following detailed description is not to be taken as limiting the scope of the embodiments or disclosure.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

It will be appreciated that for simplicity and clarity of illustration, where considered appropriate, reference numerals may be repeated among the figures to indicate corresponding or analogous elements. In addition, numerous specific details are set forth in order to provide a thorough understanding of the implementations described herein. However, it will be understood by those of ordinary skill in the art that the implementations described herein may be practiced without these specific details. In other instances, well-known methods, procedures and components have not been described in detail so as not to obscure the implementations described herein. Also, the description is not to be considered as limiting the scope of the implementations described herein.

Parking in the commercial garages is an antiquated and cumbersome process. Most of the commercial self-parking and valet garages charge customers to park into their garage. In most of the self-parking garages, when a customer arrives at the garage entry gate, a paper ticket is dispensed to the customer from a ticketing machine, or a paper ticket is handed over to the customer by a human attendant. This process is very inefficient because to collect the paper ticket a customer needs to interact with a machine or a human. This leads to risk of customer catching the germs, for example during COVID19 pandemic COVID virus infections, from the ticket machine surfaces or from human-to-human transmission. In addition, customers tend to misplace the paper tickets leading to further inconveniences and delays when they come back to retrieve their car. Further paper ticket is environmentally unfriendly due to use of a physical paper.

Furthermore, when they return back to retrieve their car, they often need to stand in the line at a pay machine, or in line for a human cashier, or fumble at the exit gates to pay the attendant or a pay machine by cash or by providing their credit cards. This not only exposes them to potential risk of catching the germs, but it also causes them significant wait times in the lines, leading to significant inconveniences and overall poor parking experience.

If it is a valet garage then they have to wait for the attendants to check them in, and attendant to physically collect the keys from the customer, and hand over the paper ticket. This is very risky for the customer as well as the attendant because both have to come into physical contact which often violates the social distancing protocols, as well as leads to needless and unfamiliar objects and surfaces touched. When the customers return to retrieve their car, they have to wait in the garage along with other customers in close proximity while valet brings their car out. If customer is happy with valet's service then they may like to tip the valet, which often is done with cash, leading to further human to human interaction and all risks and inconvenience to both the customers and the valets.

Other challenges are that with high demand of parking spaces, some customers prefer to reserve the parking spot for themselves before they arrive at the garage. These reservations could be made few hours to few days in advance. Furthermore, customers have various options available for them to make these reservations, such as, they can make the reservation directly with the garage, or 3^{rd} party resellers, or various business partners of the garage, e.g. Zoos, Theaters, Sports Stadiums, Hospitals, etc., or from the parking aggregators. With so many different options available it becomes very hard, and often manual, process for the garages to provide a seamless parking experience to the customers.

With the customers becoming more mobile, and more dependent on their smart phones, they expect a touchless parking experience where neither have to interact with any machine or human, nor want to receive or keep track of any physical paper ticket. They also want a seamless experience regardless of whether they are arriving at the garage with or without a reservation, and regardless of how they have reserved the parking. If the reservation is prepaid then they want the garage to recognize that and honor that payment rather than needing a human cashier to verify their prepaid reservations.

From the garage's point of view the challenges include that some of the garages have heavy investments in the legacy parking and revenue control systems (PARCS), they already have entry and exit gates installed, and now they want to provide this touchless experience to their customers while not throwing away investments in these legacy systems. Also, they want to fully automate their garages with minimum need for garage staff. Furthermore, they desire safety of their essential staff from the potential risks of catching germs from their customers and vice versa. In addition, they also want secure systems that may also allow them to collect their parking revenues instantly and want a system that is temper proof.

The present application presents a novel and efficient process and software system product to accomplish the various objectives desired by consumers and the parking operators.

The disclosed methods and systems work with standard web browser or SMS text messaging App that comes with every smartphone and work on any version of iPhone or any version of Android, or any other Smartphone. They do not require installation of any App and are capable of automatically identifying the garage and the gate the customer is trying to enter or exit.

The presented methods and systems are capable to automatically generate and sends the e-ticket to the customer over SMS or by Email and eliminate the need for any kind of paper ticket while keeping track of entry time into the garage and the time of stay.

The methods and systems calculate the price based on the pricing rules and time of stay and allow the customer to view and pay the electronic ticket any time. Furthermore, the customer can pay via credit card, debit card, Apple Pay, Google Wallet, or any other electronic payment system. The disclosed methods and systems are also capable to validate at the exit that the customer has fully paid before opening the exit gate.

In certain embodiments, the system may pull up the prepaid reservations for this stay and apply the prepaid amount to the bill. Other embodiments may allow for reservations made directly with the garage or through any 3rd party including but not limited to aggregators and business partners.

In certain embodiments, there may be support to apply any special discounts and promotion codes offered by the garage.

The application provides for means wherein the customer can view the electronic receipt any time, receive the receipt in the email, or customer can have a web account that may work in all the garages that uses this system.

In certain implementations, the customer may be allowed to change customer profile, add/remove payment methods, view their usage history, export the electronic receipts for reimbursement and implement additional customer centric features.

In certain embodiments, the system may include fixed posted QR code placards on the gates or a QR code Display device that is part of the system and deployed by the garage at the gates.

Other embodiments may utilize dynamically generated QR codes which may be displayed every time a customer drives up to the gate, this prevents malicious tempering with the system by the rogue customers. Certain embodiments may use geo-location and geo-fencing to validate the customer presence in the garage.

The systems and methods described are capable to be integrated with and work with any gate system and any PARCS system present in the garage. Furthermore, embodiments may work with different Vehicle Detection Systems, such as Wire loop, Wireless Detection system, LPR camera.

Certain embodiments may also include an App if a garage or parking operator prefers to have their own App. The described methods and systems are also capable to operate in Valet garages. Valet may be notified when customer checks in by scanning the QR code. System may send an e-ticket to customer phone after the car is checked in by the valet. Customer can view the e-ticket, as well as the vehicle damage report submitted by valet at the time of check-in, using their mobile phone web browser. Customer can notify the valet before they return to the garage for valet to get their car ready.

In certain embodiments, the system and methods presented may allow for various customer centric features wherein a customer can view and pay the bill using mobile phone payment methods, add tips for the valet in the bill, submit any damage claims using their mobile phone. Methods and systems presented ensure customer privacy and cloud data security.

The detailed description set forth herein in connection with the appended drawings is intended as a description of exemplary embodiments in which the presently disclosed apparatus and system can be practiced. The term “exemplary” used throughout this description means “serving as an example, instance, or illustration,” and should not necessarily be construed as preferred or advantageous over other embodiments.

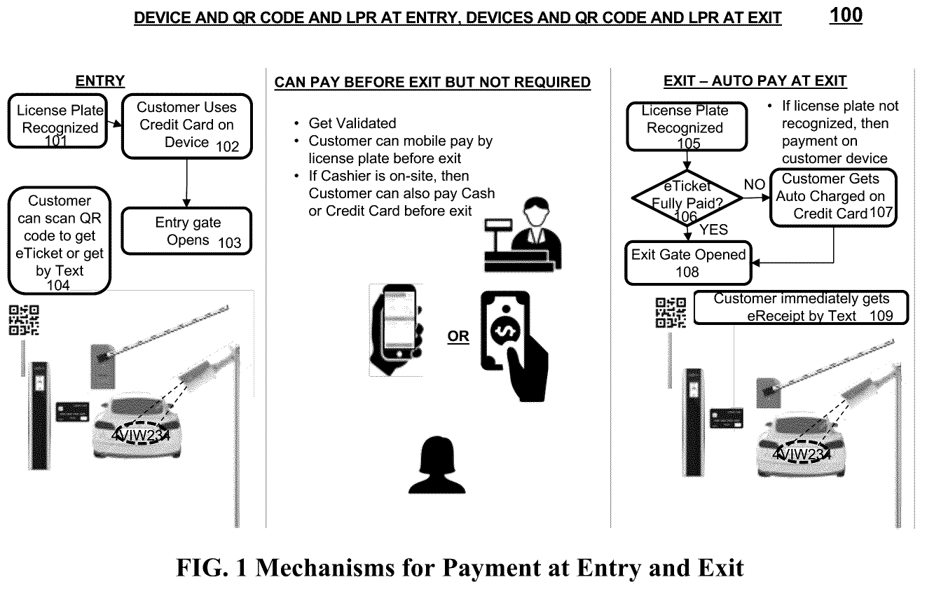

FIG. 1 illustrates in a pictorial form, the various mechanisms that may be used for managing the entry, exit and payment for an embodiment of a touchless parking system. In certain embodiments the entry to the parking structure may be controlled through the use of a camera to recognize the license plate number 101 of the vehicle. Customer may use a credit card by tapping, sliding or inserting to a compact credit card ticketless device 102 that allows the system to record the customer entry and open the entry gate 103. The compact device for processing credit card payment may be a third-party device or a custom device which may further include a camera to allow for scanning of QR codes. The customer may use such a camera to scan a QAR code and get the e-ticket vie email utilizing email or via SMS 104 to the customer's phone.

As further depicted in FIG. 1, the customer may choose to pay for parking prior to exiting the parking facility. In the alternative certain embodiments of the invention may allow the customer to get validated in the system with the vehicle's license plate number and the system may allow the customer to make a mobile payment just using the vehicle license plate number. AS in traditional parking facilities, if a cashier is on site, the customer may choose to pay the cashier in cash or credit card prior to exiting the facility.

FIG. 1 further illustrates the auto pay mechanism at the time of exiting the parking facility. A license plate reader camera recognizes the license plate 105 of the vehicle. The system may check whether the e-ticket was already paid in full 106 and if that is the case, automatically open the exit gate 108. If the e-ticket was not fully paid in advance at the time of exit the system may allow for auto charge to customer's pre-validated credit card 107 prior to opening the exit gate 108. Furthermore, the touchless parking system may send a receipt of the transaction which the customer may receive immediately by text or email 109.

The system may utilize any off-the-shelf PCI compliant unattended credit card payment device, capable of accepting EMV credit cards or MSR credit cards or Contactless credit cards, as well as built in NFC communication technology to accept smartphone payments via Apple Pay or Google Pay. Device must have a touchscreen display, and an inbuilt camera that is capable of scanning QR codes. The device must be network connectable either via wired Ethernet, USB or wirelessly via WiFi or Bluetooth.

The system may be a cloud-based system that works over the Internet and communicates with the devices that are installed at the entry and exit lanes in a parking facility. The system simultaneously communicates with multiple devices. System may also have an optional software component that may reside in the parking facility to communicate with the devices in the event the cloud-based system is not reachable because Internet is temporarily down.

The system may be a cloud-based system that works over the Internet and controls the entry and exit gates in a parking facility. The system is capable of simultaneously controls multiple gates. System may also have software component that resides in the Devices installed at the entry and exit gates of the parking facility to control the gates in the event the cloud-based system is not reachable because Internet is temporarily down.

The system may detect a vehicle present signal from the sensors installed at the entry and exit lanes in a parking facility. The system may simultaneously control multiple sensors. System may also have software component that resides in the Devices installed at the entry and exit gates of the parking facility to detect a vehicle present signal from the sensors at the entry and exit lanes in the event the cloud-based system is not reachable because Internet is temporarily down.

The system does not use or dispense any paper tickets, it is capable of working such that the customer parking his/her car in the facility does not have to touch any surfaces including the display screen on the Device and does not need to touch any buttons to receive any paper ticket or paper receipts.

In embodiments of the system, Customer drives up to the entry lane, as the car is detected by the sensors in the lane the Device is activated and messages on the screen prompt the customer to tap their smart phone on the Device, or tap the contactless credit card on the Device, or swipe an MSR credit card into MSR reader slot in the Device, or insert an EMV credit card into the EMV card slot in the Device. Customer is also prompted to scan a QR code, using the Device camera, for the cases where the customer made a prior reservation to park and was issued a QR code, or customer has purchased a prior permit to park and has a QR code. Customer may also present the same credit card that he used to pay for reservation or permit or what has been previously recorded in customer's monthly parking payment method, in which case the System would automatically recognize the reservation/permit/monthly account and not require the customer to scan the QR code. System creates an electronic ticket associated with this customer after either the customer credit card is read or customer's QR code is identified, and then the System opens the entry gate and customer is allowed to drive in and park.

Customer drives up to the exit lane, as the car is detected by the sensors in the lane the Device is activated and messages on the screen prompt the customer to tap their smart phone on the Device, or tap the contactless credit card on the Device, or swipe an MSR credit card into MSR reader slot in the Device or insert an EMV credit card into the EMV card slot in the Device. Customer is also prompted to scan a QR code, using the Device camera, for the cases where the customer made a prior reservation to park and was issued a QR code, or customer has purchased a prior permit to park and has a QR code. Customer can also present the same card they used to pay for reservation or permit or has it in his monthly parking payment method, in that case System would automatically recognize the reservation/permit/monthly account and not require the customer to scan the QR code. System retrieves from its database the electronic ticket associated with this customer after either the customer credit card is read or customer's QR code is identified, and if the customer is fully paid for the parking, then the System opens the exit gate and customer is allowed to drive out and leave the facility.

The system is a cloud-based system accessible through special devices installed at each gate in the parking facility. The end user initiates entry into the parking facility, either by tapping, sliding, or inserting their credit card into the device or by tapping their apple pay/google pay equipped smartphone on the device. If a prepaid reservation or permit is found to be associated with that user, then the ticket will be associated with that reservation or permit. Otherwise, a ticket will be created and will include the date/time, facility, and gate where the user has checked in.

When they have initiated the check in, this will open the gate if it is a gated facility or notify the valet if it is a valet facility. If the end-user does not have an existing e-ticket for a pre-paid reservation, the system will create that e-ticket; in either case, a virtual e-ticket may be saved in the system for access, when necessary, by an attendant logged into the administrative interface to the system. Each of these steps is described in detail below.

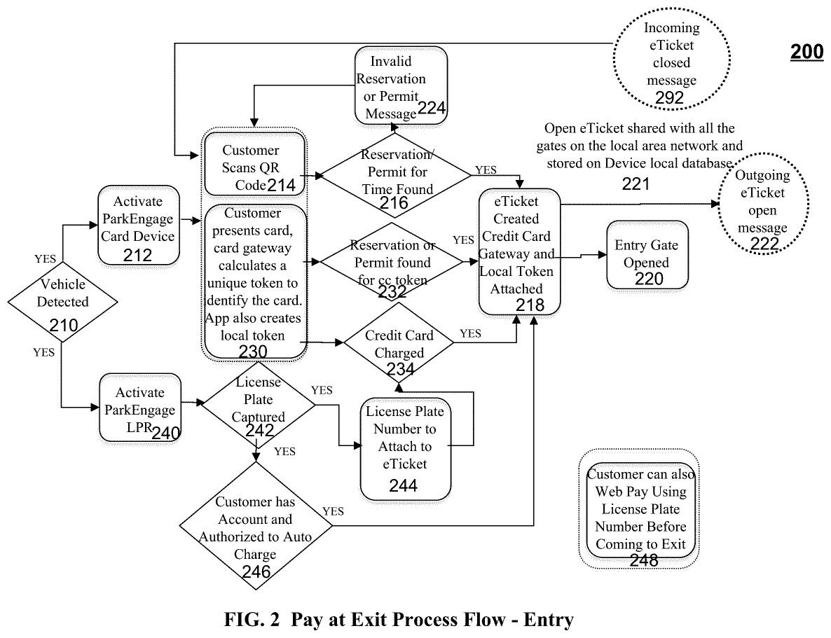

In an embodiment depicted in FIG. 2 which implements payment at exit along with a vehicle detection system as well as a license plate reader, when a vehicle arrives at the gate, the vehicle detection system 210 detects the presence of the vehicle and activates the card device 212 as well as the license plate reader 240. If the license plate is captured 242 the system may attach that license plate number to the e-ticket 244 and may also check 246 whether the customer has a prepaid account or has preauthorized a charge on the customer's credit card which has already been charged and if yes, it may forward the e-ticket to the credit card gateway 218 and open the gate 220 for the customer to access the parking lot. In embodiments, the e-ticket may also be shared with other gates and devices on the local network 221 for them to have access to the information through an outgoing e-ticket open message 222 in case internet connection is not available. Similarly, the system may receive incoming e-ticket closed message 292 from other entrance/exit points in case the vehicle exits from a different gate in the facility.

If instead, the customer chooses to use the scanner 214, the system may check for an existing reservation tied to the credit card scanned 230, or a QR code scanned 214 and may further check the information from other devices to verify whether a valid reservation exists by validating the QR code 216 or verifying the preregistration with the presented credit card 232. If no valid reservation is found, the customer may be provided a message of no existing reservation found 224. If a reservation is found, the system will generate an e-ticket and forward to the other devices on local network 221 as well as to the gateway 218 on the cloud. The system in FIG. 2 also illustrates a further check whether the credit card was charges 234, which may be included for one or all mechanisms for entry into the parking garage, the license plate recognition, QR code or pre reserved spot using a credit card or registration in the system. On creation of an e-ticket 218, the gate may be opened 220 for the vehicle to enter the facility.

The system may also provide for the customer to web-pay using the license plate number before coming to an exit gate 248 in which case the exit gate will automatically open on detecting/verifying the customer e-ticket details.

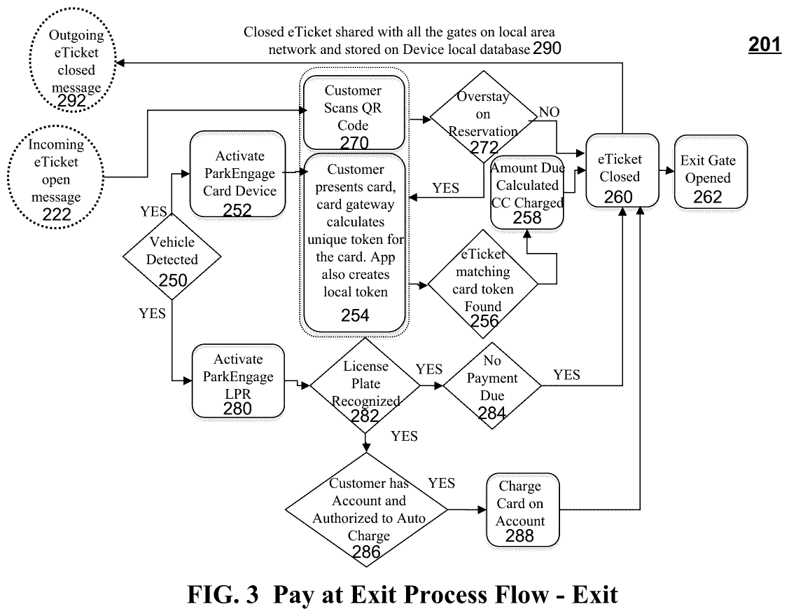

Now referring to FIG. 3, when the customer wants to exit the parking facility, the vehicle detection system 250 may detect the presence of a vehicle, the license plate reader 280 may try to match the license plate to an existing ticket. If the license plate is recognized 282 and no payment is due 284, the e-ticket may be closed 260 and the exit gate opened 262. If a payment is due and the customer has an account and preauthorized auto charge 286, then the card may be automatically charged 288, the e-ticket closed 260 and the gate opened 262. In the alternative, the customer may provide the same credit card which was used to enter the garage or used for prepaid reservation or associated to a customer account to the compact touchless credit card device 252, in which case the system may match the e-ticket 256 with the customer and if no payment due, then the system may close the e-ticket and open the gate for the customer to exit. If there is a payment due, then the system may charge the credit card the extra amount and close the e-ticket and open the gate for customer to exit. The information regarding closing of the e-ticket is also sent to the other devices on the network 292 through the use of outgoing e-ticket closed message 292 so that each of those nodes have the current information about the open and closed e-tickets. Similarly, another mechanism used may be through the receipt of an incoming ticket open message 222 or the customer scanning a QR code 270 to initiate the processing of the vehicle for exit. If a customer overstayed the amount of time that was reserved for the parking 272 then the system may request the customer to present the card for further payment 254 prior to the customer exiting the facility.

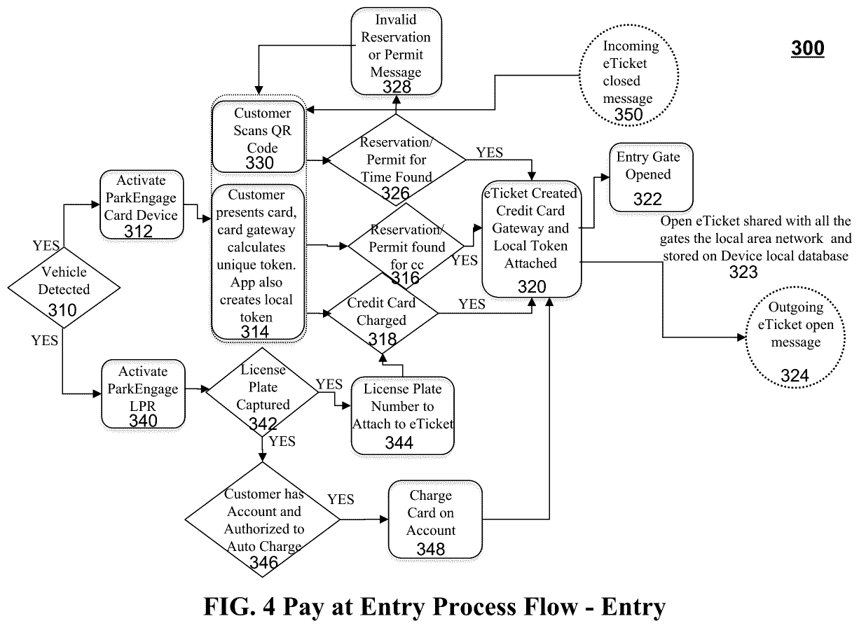

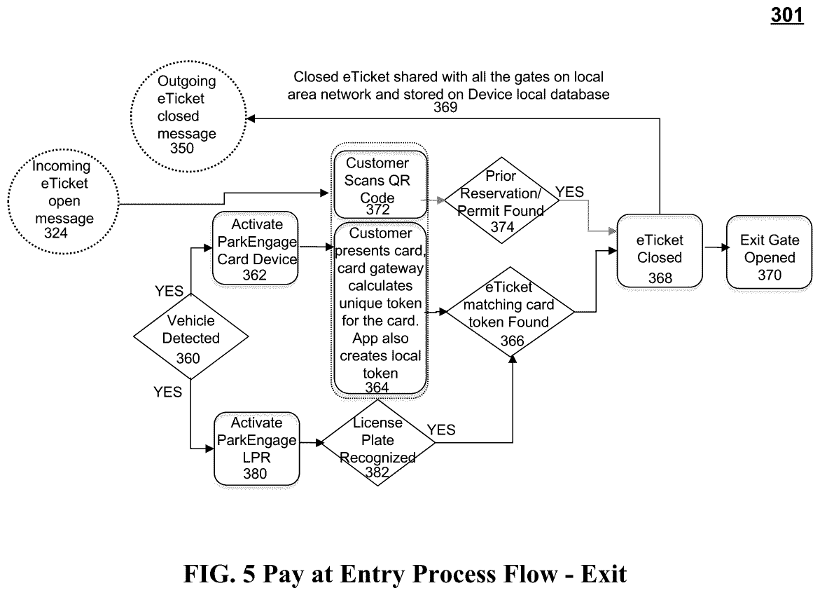

FIGS. 4 and 5 illustrate the flow process for a similar embodiment where the customer's credit card is charged at entry instead of at the time of exiting the garage.

In an embodiment depicted in FIG. 4 which implements payment at entry along with a vehicle detection system as well as a license plate reader, when a vehicle arrives at the gate, the vehicle detection system 310 detects the presence of the vehicle and activates the card device 312 as well as the license plate reader 340. If the license plate is captured 342 the system may attach that license plate number to the e-ticket 344 and may also check 346 whether the customer has a prepaid account or has preauthorized a charge on the customer's credit card and charge the card on account 348 before forwarding the e-ticket to the credit card gateway 320 and open the gate 322 for the customer to access the parking lot. In embodiments, the e-ticket may also be shared with other gates and devices on the local network 323 for them to have access to the information through an outgoing e-ticket open message 324 in case internet connection is not available. Similarly, the system may receive incoming e-ticket closed message 350 from other entrance/exit points in case the vehicle exits from a different gate in the facility.

If instead, the customer chooses to use the scanner 312, the system may check for an existing reservation tied to the credit card scanned 314, or a QR code scanned 330 and may further check the information from other devices to verify whether a valid reservation exists by validating the QR code 326 or verifying the preregistration with the presented credit card 316. If no valid reservation is found, the customer may be provided a message of no existing reservation found 328. If a reservation is found, or the credit card is charged 318, the system will generate an e-ticket 320, open the gate 322 and forward the e-ticket information to the other devices on local network 323 as well as to the gateway 320 on the cloud. The system in FIG. 4 also illustrates a further check whether the credit card was charges 318, which may be included for one or all mechanisms for entry into the parking garage, the license plate recognition, QR code or pre reserved spot using a credit card or registration in the system. On creation of an e-ticket 320, the gate may be opened 322 for the vehicle to enter the facility.

Now referring to FIG. 5, when the customer wants to exit the parking facility, the vehicle detection system 360 may detect the presence of a vehicle, the license plate reader 380 may try to match the license plate to an existing ticket. If the license plate is recognized 382 and a matching e-ticket or token is found 366, the e-ticket may be closed 368 and the exit gate opened 370. In the alternative, the customer may provide the same credit card which was used to enter the garage or used for prepaid reservation or associated to a customer account to the compact touchless credit card device 364, in which case the system may match the e-ticket 366 with the customer and the system may close the e-ticket 368 and open the gate 370 for the customer to exit. The information regarding closing of the e-ticket is also sent to the other devices on the network 369 through the use of outgoing e-ticket closed message 350 so that each of those nodes have the current information about the open and closed e-tickets. Similarly, another mechanism used may be through the receipt of an incoming ticket open message 324 or the customer scanning a QR code 372 to initiate the processing of the vehicle for exit.

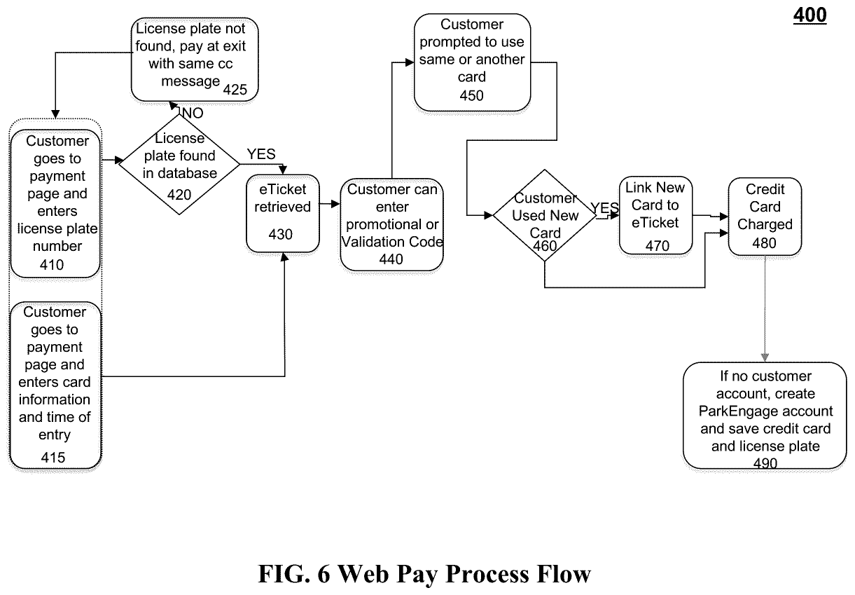

FIG. 6 illustrates the process for the customer to make the payment using a website. In embodiments, the customer may choose to provide the license plate number 410 if the vehicle has been previously registered with an account for that parking garage or a credit card 415. If the provided license plate is not found 420 the system may prompt the customer 425 to use the same credit card to enter and exit the garage. In embodiments, once the e-ticket for the customer is retrieved 430, the customer may be prompted to provide any validation or promo codes 440 which may be used to adjust the parking charges before charging the credit card or the customer's account with the adjusted parking fees. Customer may be prompted to use the registered credit card or a different card 450. In case the customer desires to use a different credit card then the one registered with the account 460, the system may allow for the customer to enter a new credit card number 470 and link that credit card to the customer's account. The credit card may be charged 480 and if there is no customer account a new customer account may be created 490 prior to the customer using the facility.

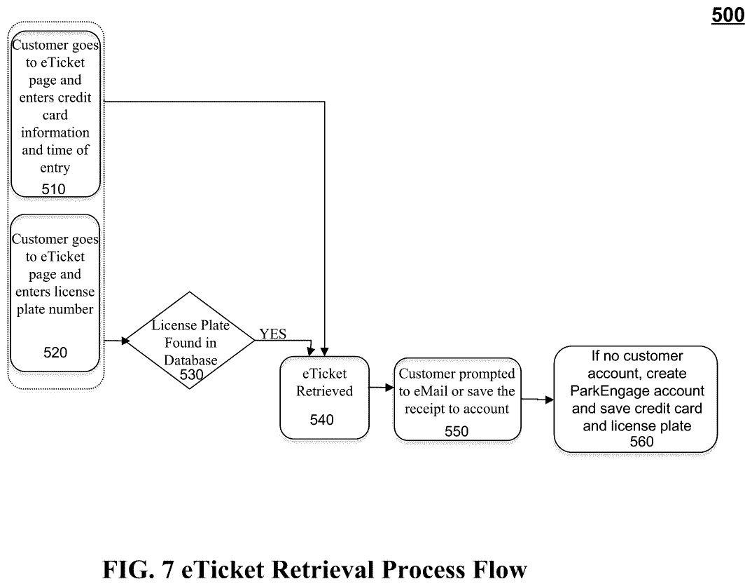

FIG. 7 illustrates the process through which a customer may retrieve the parking receipt from the system. In embodiments, the customer may choose to provide the license plate number 520 if the vehicle has been previously registered with an account for that parking garage or the associated credit card 510 that allows the system to verify that the license plate is available in the database 530 and for the system to retrieve the e-ticket 540. Once the customer's e-ticket has been retrieved 540 through the use of customer's registered license plate or a credit card, the customer may be prompted to save the receipt or choose for the receipt to be emailed to the customer 550. If the customer does not have a preexisting account, the customer may be prompted to create a new account and the credit card info and/or the license plate may be linked to the new account 560.

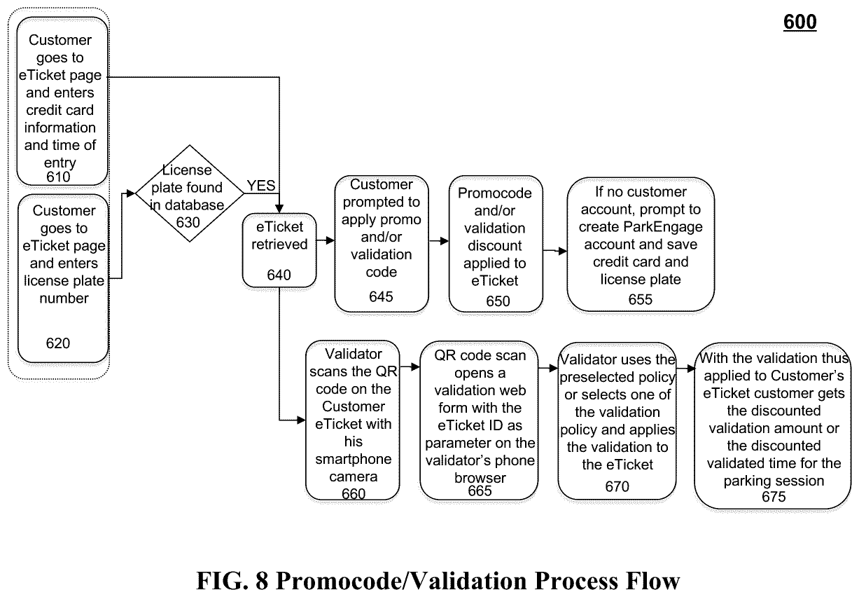

FIG. 8 depicts the process by which a validation code or a discount provided to a customer may be applied to the customer's charges for parking. In embodiments, the customer may choose to provide the license plate number 620 if the vehicle has been previously registered with an account for that parking garage or the associated credit card 610 that allows the system to verify that the license plate is available in the database 630 and for the system to retrieve the e-ticket 640. Once the e-ticket has been retrieved the system may prompt the user to provide any validation or discount codes to be applied 645. The entered discount or validation code may be applied 650 to the customer's e-ticket and the adjusted amount charged to the customer's credit card or account. In the alternate validation process a validator would simply scan the QR code on the customer e-ticket 660 that would open a web page on his smartphone browser 665 from there validator can apply the validation to customer's e-ticket according to the predefined validation policy defined by the business for the validation 670. Once the validation or promotion has been applied to Customer's e-ticket customer gets the discounted validation amount or the discounted validated time for the parking session 675. If no customer account is found, the system may prompt the customer to create ParkEngage account and save credit card and license plate information to receive the promotion 655.

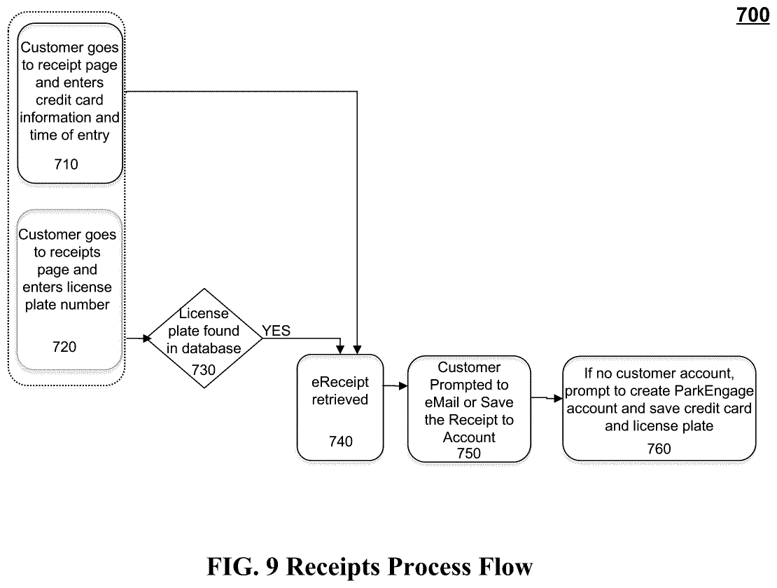

FIG. 9 depicts in a flow chart form the e-ticket retrieval process discussed earlier through which the customer may access the parking receipt at the gate or by using a website. In embodiments, the customer may choose to provide the license plate number 720 if the vehicle has been previously registered with an account for that parking garage or the associated credit card 710 that allows the system to verify that the license plate is available in the database 730 and for the system to retrieve the eReceipt 740. Once the eReceipt has been retrieved the system may prompt 750 the user to save the eReceipt to customer account or get the eReceipt emailed to the customer. In various combinations of the type of system implemented in an embodiment, the customer may be prompted to create an account on the system if the customer does not happen to already have an account 760.

Further functional discussion of the various elements of the system is provided below for clarity.

### Touchless Entry

Since the same device is used to allow the entry and exit to all the customers regardless of whether they have prior reservation, permit or they are monthly parking customers, or whether they are entering by presenting their credit card at the device, the disclosed invention determines the customer's intent without requiring customer to touch any buttons on or off the device screen to specify their intention. The System does this by simultaneously turning on both the camera on the device to read QR code, as well as the credit card reader on device to read the credit card, without requesting the customer to select any button to specify whether they want to use QR code or the credit card. Then depending on whether the customer scans the QR code or presents the credit card application on the device, the System takes the appropriate actions to determine whether customer has a prior reservation or permit, or he is a monthly parking customer, or else if he is using credit card for entry. This allows for a completely touchless entry to the customer.

### Initial Entry to the Facility

Initial entry to the facility maybe granted by the user scanning a QR Code at the entry point using the camera on their smart device or through the use of license plate camera to read the vehicle's license plate. The License Plate reader may create a e-ticket using the license plate information for keeping track of the vehicle's entrance and exit from the parking facility. This QR code usage requires the end-user's smart device camera to be enabled for the scanning of QR Codes. When the QR Code is scanned, an SMS message may be composed automatically on the end-user's smart device; this SMS text message may be directed to a phone number associated with the parking operator which operates the facility they are attempting to enter, and the body of the text message may be a string of ascii characters encoding the date/time, the facility, and the entry point of the facility. The customer must press send on the SMS text message to check-in to the facility and create the e-ticket if one does not already exist through the use of pre-paid reservation process.

If the end-user experiences any difficulty entering the facility, the administrative console disclosed in the application also provides a facility administrator with the ability to open the gate for the end-user and to initiate the creation of the e-ticket which may be sent to the end-user via SMS text message.

### Composition and Display of the Qr Code

The QR Code may, at a minimum, be composed to include the facility identification and the entry point identification within that facility. For this basic composition of QR Code, the QR Code may be preprinted on a placard that is mounted at the entry point of the facility that it is identifying.

Another embodiment of a more secure premium version may have a smart digital display device located at the gate, that may light up when the vehicle is detected in the lane and it may display the dynamically generated QR code. Customer may scan that code with the phone camera App and once the car moves out of the lane, the display may go blank till a new car comes and that's when it may show a new QR code. Smart Display may either be connected to the ParkEngage cloud over the Internet, where the code may be generated in the cloud and pushed to the Display, or alternatively, the display may work in disconnected mode and may have a proprietary logic built in the Smart Display device to generate unique QR code that ParkEngage cloud may be able to decode.

A more secure version of the QR Code may be composed as above but also include the date/time that the QR was generated and a random number that falls within a range of numbers that may be associated with the particular facility and entry point that the QR Code is identifying. In this case, the QR Code may be generated by and displayed on an electronic smart display that is mounted at the facility entry point which it identifies.

This more secure version of the QR Code may be used to prevent an end-user from sending a duplicate SMS message to trigger a check-in when they are not physically present at the facility entry point.

In embodiments, at the time of setup of these Smart Display Devices in each garage entry and exit lane, unique garage name and specific gate code may be fed into the device through a touchscreen, the built-in logic may use these two pieces of information to generate the unique QR code which may also use the timestamp every time to make it a unique QR code. During setup the QR code may be sent to ParkEngage cloud via SMS. This first text may be used to calibrate the cloud with the device.

Once setup is completed the Smart Display Device may be ready to use to display the QR codes whenever a vehicle is detected in the entry or exit lane where the display device is deployed.

### Creation of the E-Ticket

In addition to creation of an e-ticket using a vehicle's license plate information, when using the QR code, when a validated SMS text message is received, the cloud system may identify the facility, entry point, date/time, and end-user phone number and may first search for a pre-existing e-ticket that may exist for that end-user for that facility for the same date that has been pre-paid. If no such e-ticket is found within the cloud system database, then a new e-ticket may be created for this stay for this end-user at this facility. The e-ticket may be uniquely identified with a ticket number and may be stored in the cloud system's database.

In either case of a new e-ticket or a pre-existing e-ticket, an SMS message may be sent back to the end-user's phone number that may include a link to the e-ticket on the cloud system's webserver.

As previously noted, the administrative console also may provide this functionality to a facility administrator to be able to create the e-ticket on behalf of the end-user in case of any end-user difficulty in entering the facility. The administrator may also resend the e-ticket to the end-user at any time if the user should lose access to their original e-ticket.

### Checking in the Customer

After the e-ticket has been created and sent via SMS to the end-user, the end-user may be checked into the facility. Depending on the facility as either a gated, self-service facility or a valet parking facility, the system may either open the entry gate to enable the user to enter or may notify the valet of the end-user's presence for the vehicle to be valet parked.

Again, a facility administrator may also check in the end-user on an e-ticket using the administrative console described below

### Opening the Gate to a Gated Facility

The cloud system may be enabled to open the gate of a gated facility by calling an API that is provided by the gate vendor. This API may be accessible over the internet from the cloud system and each gate vendor may have their own proprietary API to open the gate. The proper API for the cloud system to use may be specified for each entry point to each facility so that any facility may take advantage of different gate equipment for each entry and may change their gate equipment over time.

The gate system may or may not have an associated vehicle presence detection system (wire-loop or other detection system). If such a system is to be used by the cloud system, the vendor may also provide their internet accessible API for detecting whether or not a vehicle is present. As with the gate API, this API may be specified within the cloud system for each facility entry point and any facility may have vehicle detection system from different vendors with different APIs.

If such a system is present, the cloud system may first check for the presence of a vehicle prior to searching for an e-ticket, creating and e-ticket, opening the gate, or notifying the valet. In embodiments, these actions may only be enabled at any entry point which has a vehicle detection system when a vehicle is detected.

As noted previously, a facility administrator may also open the gate at any time via the administrative console described below. In this case, the administrator may also see the vehicle detection system status for each entry and exit point for all entry and exit points that have a vehicle detection system installed and configured within the cloud system. However, a facility administrator using the administrative console may open any gate at any time whether the vehicle detection system is currently detecting vehicle presence or not.

Accessing the E-Ticket for Payment or Exit from the Facility

When the end-user has parked their vehicle in the parking facility or turned their vehicle over to the valet in a valet facility, the end-user may access the e-ticket at any time by clicking on the link to the e-ticket in the SMS message that was sent to their smart device.

When they access their e-ticket, multiple functions may be available for the end user may perform and the availability of each of these functions may vary from one facility to another depending on the services that are offered by each facility:
a. End-user may specify the parking location of their vehicle or the valet location to retrieve their vehicle.
b. End-user may update their profile information including their phone number, vehicle identifying information (make, model, year, type, license plate number, etc.), address information, payment method information, expected return time.
c. End-user may request additional services from the parking operator if the operator offers such services. The services that the end-user may request may be enumerated within the cloud system for each facility separately and for each service there may or may not be an additional price associated with each service—these things may all be specified by the operator while setting up the cloud system. For example, the parking operator may offer car washing and detailing services, vehicle inspection services, vehicle maintenance services, concierge services, etc. at the operator's discretion.
d. The end-user may notify the valet, in the case of a valet facility, of their updated return time in order for the valet to have their vehicle ready and waiting for them upon return.
e. The end-user may pay for their current parking charges at any time using an electronic payment method that may include credit card, google pay, apple pay, electronic bank transfer, promotional codes, customer account credits.
f. The end-user, when at a facility exit point, may access the e-ticket for the purpose of checking out of the facility.

A facility administer may access all of these same functions on an end-user's behalf should the end-user have any difficulty with using any of the functionality by accessing the administrative console described below.

### Electronic Receipts

The system is a completely paperless system. It does not dispense paper parking tickets and it does not issue any paper receipts for the payment made by the customer. Instead, it generates electronic receipts that customers can receive by email or by SMS or by going to a website. As the customers pays on the entry or exit by tapping or swiping or inserting their credit card on the device or by tapping the smartphone on the device, a QR code is displayed on the device, which customer can scan with their phone, this generates an SMS request that gets sent from customer phone to the Cloud system, in response to this request Cloud System sends the electronic receipt back to customer by SMS. Alternate QR code displayed on the Device can be scanned by the customer from his phone and that would take the customer to a website and display the electronic receipt on a webpage, which customers can choose to receive as an email by specifying their email ID and the Cloud System will email the electronic receipt in form of PDF to the customer email provided to the system.

Customer can also choose not to receive the electronic receipt at the gate, instead customer can scan a QR code displayed in the parking facility, that scan of QR code would take the customer to a webpage, where customer can specify the last four digits of their credit card they used on the Device at the gate, and specify the approximate time the payment was made at the entry gate or at the exit gate. With this information Cloud System would retrieve the customer's electronic receipt and display it on the webpage. Customer can either email or SMS the electronic receipt.

If the customer has a prior user account setup with the Cloud System, and the credit card customer used to pay for the parking is stored in that account then an electronic receipt would be automatically saved in the customer account every time customer makes the payment. Customer can view or email or download the electronic receipt from his account at any time.

If the customer makes the payment for parking online, instead of using the credit card on the Device at the gate then the electronic receipt would be displayed to the customer on the webpage once the online payment is successful. Customer can further email, SMS or download the electronic receipt. If the customer has a user account with the Cloud System, then electronic receipt would be saved in the user account online, which customer can view, email or download.

### Parking Validations

Parking validations are common in parking industry where the customer parks in a parking facility and visits a business using the parking facility for its customers. In certain cases, the business may validate customer's parking ticket thus giving customer free or discounted parking. Since customer does not get paper ticket for parking using this Cloud System, businesses can validate customer's electronic ticket in the following ways:
a. Business can go to a website associated with the Cloud System and specify the Customer's credit card information and time of entry to retrieve customer electronic ticket and electronically validate the customer's electronic ticket. When customer returns to parking facility and pays for parking then discounts given by the business are automatically applied.
b. Business can also give a validation code to the customer which can be applied at the time of payment to get the discount given by the business towards parking charges.
c. Customer can also receive this validation code electronically by scanning a validation QR code provided by the business or receive it via email or SMS sent by the business. Customer can apply this validation code if the customer is paying online. If the customer is paying at the exit, then customer would first scan the validation QR code on the Device camera and then would be prompted to present the credit card to the Device. System would apply the validation to the customer's electronic ticket and apply the discount given by the business towards parking charges.

Parking validation is any sort of mechanism whereby the parking operator enables a third party to take responsibility for some or all of a parking patron's parking fee. The willingness of the third party to take responsibility for a particular parking patron's parking fee is typically indicated by the provision of some sort of mark or voucher to the parking patron which they can provide to the parking operator as a form of payment. Historically, this mark or voucher may take the form of a punch hole in the ticket or a unique sticker placed on the ticket. More recently, with the advent of digital tickets and mobile payment systems, this has taken the form of a “validation code” that is provide to the parking patron to enter into their ticket as a form of payment.

The problem with this digital solution for validation is that the code that is provided is typically not a dynamic code. Therefore, the parking patron may potentially use this same code in the future to validate their parking without actually patronizing the third party who provided the validation code. A further problem is that this code may become known to other parkers who have never patronized that third party at all.

The present application discloses a system for validation which solves this security/reuse problem and also provides a more flexible system for validation that was historically available in the days of physical marks or vouchers for validation. Furthermore, the disclosed solution provides flexibility in the validation setup and process that has not been available historically and that is not provided by the validation code method of validation today.

The validation setup process begins with establishing the validation policies that will be used by various third parties when validating their patron's parking. These policies have many parameters that can be applied to control how the parking validation may be applied including:

Validation by hours, dollars, or percentage—a particular validation policy may credit a certain number of hours from the parking, a certain dollar credit towards the parking, or a percentage discount on the parking.

Fixed validation amount or dynamic validation amount—the amounts applied, whether hours, dollars, or percentage, can either be set up as fixed amount which will apply to all validations under this policy or can be dynamic and the amount assigned on a case by case basis.

Activation date and Deactivation dates on validation policy—the policies can be set to automatically activate and deactivate on specified dates, this also facilitates the ability to change validation policies over time.

Maximum validation amounts per time period—the amount of validation that can be provided can have a maximum associated with a time period—the time period can be daily, weekly, monthly, quarterly, or annually and as a result this would constrain the total amount of validation that can be provided to a maximum amount and this would reset at the end of each time period so that the full amount is again available for the next time period.

Association of different validation policies with different parking facilities—a particular third party may validate parking across multiple parking facilities.

Delegation of Validator setup to the third party—there may be a hierarchy of setup to facilitate the above capabilities. Policies that might be used across different validators these are setup by the parking operator; Validator Entities—these are setup by the parking operator initially; the validator account setup may include the mapping of which policies apply for which of the operator's facilities; individual validator users—these maybe setup by the validator account—the validator may establish individual user account who may perform validations on their behalf and these individual user account may be set up for which policy can be applied for each facility limited by the policies that have been made available to the validator by the operator—for example, the validator may set up a policy of one hour validation to be given by the cashier for typical use but may set up a manager user to be able to validate for 100% validation.

A customer simply displays their eTicket on their mobile device, the eTicket includes its own QR Code which the validators may scan using their smartphone camera. This scan will automatically activate the validation function in accordance with the validation policy attached to the user logged in on that phone. If the validation is a fixed type of validation, then the process is complete. If, however, the validation policy for this validator is a dynamic validation then the validator may simply enter the amount of validation to apply (whether in units of hours, dollars, or % is determined by the policy) and press the validate button to complete the process.

Customer can self-validate their parking eTicket by scanning a posted QR code. Customer can scan the validation QR code using a link within his eTicket, that would open the self-validation link and automatically link the customer eTicket to the validation request. Once customer completes the request his eTicket would be validated as per the configured validation policy. If customer does not have eTicket then customer would be prompted to provide his credentials and customer eTicket would be fetched and validation according to configured validation policy will be applied.

Self-validation via a posted static QR code is subject to abuse. To protect from such abuse self-validation may be implemented by using a dynamic QR code. A dynamic QR code may be displayed on an electronic display, as the customer scans the dynamic QR code it would validate the customer eTicket, or customer would be prompted to provide his credentials to fetch the eTicket that needs to be validated. Once the eTicket is validated the dynamic QR code may be automatically refreshed on the electronic display, and a new unique QR code would be displayed for the next customer to use to validate his eTicket. These dynamic QR codes may also have a timestamp and sequence associated with them so that nobody can take a picture of the dynamic QR code and try to use it later out of sequence.

### Parking Promocodes

Promocodes are commonly used by parking facility operators to attract customers. Promocodes are redeemed by the parking patrons to get discounts for their parking charges. Customer can redeem promocodes in following ways:
a. If customer has an account setup in the Cloud system, then customer may simply save the promocode in their account. When the customer presents the credit card linked to the customer account to the Device for payment, Cloud System would apply the promocode to the customer's parking charges.
b. Customer can also scan a QR code displayed in the parking facility, that scan of QR code may take the customer to a webpage, where customer may specify the last four digits of their credit card they used on the Device at the gate and specify the approximate time of entry into the garage. With this information Cloud System would retrieve the customer's electronic ticket, and the customer can simply specify the promocode in that electronic ticket. Whenever the customer is ready to pay for parking, either by going online and making payment or by presenting the credit card at the exit, the promocode discount would automatically be applied to the payment.
c. If the customer does not have an account in the cloud system and the parking facility charges for parking at the entry gate when the customer presents the card to the device in the entry lane, then if the customer wants to redeem the promocode then Customer would scan a QR code displayed in the parking facility, that scan of QR code would take the customer to a webpage, where customer can specify the last four digits of their credit card they used on the Device at the gate, and specify the approximate time of entry into the garage. With this information Cloud System would retrieve the customer's electronic ticket, customer can simply specify the promocode in that electronic ticket, cloud system would refund the discounted amount to customer credit card.
d. Promocodes can also be given to the customer in form of a QR code. Customer may scan the Promocode QR code at the Device by the gate and the Cloud system would apply the Promocode discount to the electronic ticket, so when customer pays for the parking, the discount is applied.

### Payments

Customer may pay for parking in following ways:
a. If the parking facility requires the payment at the entry, then as the customer presents the card at the Device on the entry gate he would be charged for the parking.
b. If the parking facility charges the customer after the parking is completed then the customer can pay at the exit gate, by presenting the same credit card which was used at the entry gate to the Device at the exit gate. Cloud system will fetch the corresponding electronic ticket and calculate the amount customer owes and charge the customer's card.
c. In the case where the parking facility charges the customer after the parking is completed, the customer may also pay online before driving to the exit gate. Customer would scan a QR code displayed in the parking facility, that scan of QR code would take the customer to a webpage, where customer can specify the last four digits of their credit card they used on the Device at the gate and specify the approximate time of entry into the garage. With this information Cloud System would retrieve the customer's electronic ticket, Cloud System will calculate the parking charge corresponding to that electronic ticket, and customer can pay that amount. Customer also has the opportunity to apply any Promocodes or Validations at the time of this payment, as described in previous sections. After payment customer drives to the exit gate and presents the same credit card that was used at the entry gate to the Device at the exit gate. Cloud system will fetch the corresponding electronic ticket and since the electronic ticket is fully paid, Cloud system may open the exit gate and customer is allowed to exit.

### Exiting the Facility

When the end-user accesses their e-ticket and selects the check-out functionality, the cloud system may first check whether or not the end-user has fully paid whatever fees are due for parking and other services that have been ordered. If there is any amount owing, then the end-user may be prompted to pay their parking and other fees prior to enabling exit from the facility or notification of the valet (in the case of a valet facility).

Once full payment has been verified, the e-ticket may open the camera on the end-user's smart device and request them to point the camera at the QR Code at an exit point. When the end-user camera scans the QR Code at the exit point, the cloud system may verify once again that the user has paid all fees and request payment if any fees are due. If there is no amount owing, the vehicle detection system, if setup for this exit point, may be checked for the presence of a vehicle and if vehicle is present, the cloud system may call the API to open the gate if it is a gated facility. Finally, the cloud system may mark the e-ticket as having been checked out with the date and time stamp and the e-ticket may be marked as closed.

This function may also be accessible to a facility administrator using the administrative console described below to enable facility exit for the end-user should the end-user have any difficulty with accessing this functionality.

### Use of License Plate Recognition (LPR) Camera

Optionally LPR Cameras can be used along with the Device at the entry and exit lanes to make the customer experience more frictionless and touchless. Following describes how LPR camera may be used in this system:

When a customer drives up with a prior reservation or permit to park or if the customer is a monthly parker, and the customer specified the car license plate number at the time of purchase of reservation, permit, or monthly account setup in the Cloud system, then as the customer reaches the entry lane, the license plate is recognized and matched to prior reservation, permit or monthly account, and the gate is opened and customer is allowed to drive in.

When a new customer without prior reservation, permit or monthly account, drives up then the customer is required to present a credit card at the Device on the entry gate, this opens an electronic ticket, also at that time the license plate is recognized by the LPR camera and attached to the electronic ticket, and the customer is allowed to enter. At the time of exit, as the customer drives up to the exit gate, the license plate is recognized by the LPR camera at the exit gate and the corresponding electronic ticket is fetched by the Cloud system. The parking charges associated with that electronic ticket are automatically charged to the customer's credit card that was presented at the Device on the entry lane, and then exit gate is opened and the customer may simply drive out.

System Continues to Function when Internet Connection is to Cloud System is Down

In the event the Internet connectivity to the parking facility is down and the Devices in the parking facility cannot communicate with the Cloud system, Devices may be setup to work as a network of devices to exchange information about the checked-in electronic tickets with the devices at the exit gate. Thus any customer who was checked in by presenting his credit card or smartphone payment method at the entry gate would still be able to check out at the exit gate by presenting the same credit card or the smartphone payment method at the exit gate. Credit card or smartphone payment would be accepted locally on the device and transaction information may be stored locally and later on, when the internet connection is reestablished, all of the locally saved transactions may be forwarded to the Cloud system payment gateway for clearance.

All the devices at the entry and the exit gates in a garage facility may be connected over a local area network, in addition to them being connected to the cloud over the Internet. When the customer checks in at the entry by presenting the credit card the payment application on the device communicates to the gateway, which in turn computes a token that is always unique for every credit card, and this token may be used to identify the credit card even though specific card information like credit card number stays encrypted as per the PCI guidelines.

Simultaneously the application on device may also receive partial credit card information like the type of card, last 4 digits of card number, expiration date and zip code etc., which the application may use to create a local token. This local token may be saved with the electronic ticket and the electronic ticket may be shared with all the devices on the local area network for them to save it on their local database. This local token has a high likelihood to be unique for all the open electronic tickets at the facility for the limited parking duration. If there are more than one electronic tickets found where the token is same then the customer may be asked for additional information like time of entry to differentiate between the electronic tickets with same information. At the exit gate device computes the local token again when the card is presented, and from the local token an open electronic ticket may be identified from the local device database. If the payment is due and the Internet is down and the payment gateway in the cloud is not reachable, then the application may use the store and forward function of the payment application to store the transaction and close the electronic ticket locally and open the exit gate to allow the customer to exit. Later on, when the Internet connection is reestablished all the locally stored transactions are forwarded to the payment gateway to be approved and charged to the credit card. Once the electronic ticket is closed at the exit, all the other devices on the network are informed so that they can update their local databases.

### Administrative Console

All of the functionality described above may be available to a facility administrator via the web based administrative console provide as part of the system as described above.

In addition, this administrative console may provide a facility administrator with additional capabilities that are not part of the end-user functionality including the following functions.
a. Cloud System Configuration—all system set up and configuration details may be configured through the administrator console.
b. All end user functionality—administrator may invoke any end-user functionality on behalf of a particular end-user should the end-user have any difficulty accessing any of the functionality themselves.
c. Monitoring and Management—all data within the cloud system may be monitored and managed by a facility administrator via the administrative console. This includes access to e-tickets, monitoring of the status of vehicle detection system, monitoring and control of individual gates.
d. Reporting—reporting of transaction details and summaries may be available through the administrative console as well as all other cloud system activities including end-user entries and exits, end-user service requests, payments owning or paid, etc.
e. Business Intelligence—a variety of business metrics and analytics may be made available through the administrative console.

In certain embodiments the check in process may include the following steps. Users enter the entry lane in the parking garage and scan the QR code (SMS type) through QR code scanner enabled Camera or any other QR Code scanner app at the entry gate. Once a user scans the QR code, the default native SMS app may open with a predefined sender number and predefined SMS with some encrypted message.

Once a user sends the predefined SMS, SMS gateway may send that message to ParkEngage cloud server and cloud may decrypt that message, if the message gets validated and verifies that the vehicle is present at the entry gate the user may get the SMS reply with thank you message and a Check-Out link. On return users may click the check-out link received through SMS during check-in.

When the user returns to retrieve the vehicle, the check-out process may include the following steps. Once a user clicks the Check-out link user may be redirected to the check-out screen. The Check-Out screen may display the payment details along with check-in/out details. Once a user clicks the proceed to check-out button and payment is done the user may be redirected to the QR code scanner page or screen. User may be prompted with a message in case of any error. Once a user scans the QR code through a web page or screen, ParkEngage server may verify the data and check if the vehicle is present at the exit gate, gate may open through ParkEngage cloud server, and the user may redirect to the thank you page.

In certain embodiments, user may scan the QR code (SMS type) through QR code scanner enabled Camera or any other QR Code scanner app at the entry gate. Once a user scans the QR code, the default native SMS app may open with a predefined sender number and predefined SMS with some encrypted message.

Once a user sends the predefined SMS, SMS gateway may send that message to ParkEngage cloud server and cloud may decrypt that message, if the message gets validated and checks if the vehicle is present at the entry gate the user may get the SMS reply with thank you message and Check-Out link.

The checkout process in this exemplary embodiment may include the following steps. User reaches the exit gate after some period of time. User clicks the check-out link received through SMS during check-in. Once a user clicks the Check-out link user may be redirect to the check-out page. The Check-Out page may display the prepaid booking details along with check-in/out details. Once a user clicks the proceed to check-out button user may be redirected to the QR code scanner page or screen. User may be prompted with a message in case of any error.

Once a user scans the QR code through a web page or screen, ParkEngage server may verify the data If there is any overstay amount pending, the user may redirect to the payment screen where it may show the balance or overstay amount. Once the server has verified the payment, user may be again redirected to the QR code scanner screen. Once again, the user scans the QR code through a web page or screen, ParkEngage server may verify the data and check if the vehicle is present at the exit gate, gate may open through ParkEngage cloud server and the user may be redirected to the thank you page.

In an embodiment that implements the Web URL Type QR Code with prepaid booking, the check in steps may comprise of the following action steps. User may enter into the parking. User may scan the QR code (URL type) through QR code scanner enabled Camera or any other QR Code scanner app at the entry gate.

Once a user scans the QR code and clicks the link, the default browser may open with a predefined URL and encrypted query string. URL may open the Welcome page with input fields email and phone number. Once a user enters a phone number and email and clicks the submit button, ParkEngage server may verify the data and check if the vehicle is present at the exit gate, gate may open through ParkEngage cloud server, and the user may redirect to the Check-In page details.

Similarly, in this exemplary embodiment, the check-out process may include the following steps utilizing a web link for checking out: User reaches the exit gate after some period of time. User clicks the check-out link received through email during check-in. Once a user clicks the Check-out link user may redirect to the check-out screen. The Check-Out screen may display the payment details along with check-in/out details.

Once a user clicks the proceed to check-out button and payment is done the user may redirect to the QR code scanner page or screen. User may prompt a message in case of any error. Once a user scans the QR code through a web page or screen, ParkEngage server may verify the data and check if the vehicle is present at the exit gate, gate may open through ParkEngage cloud server and the user may redirect to the thank you page.

In certain embodiment, the check-out process may use a QR code instead of a web link and the process may involve the following steps: User reaches the exit gate after some period of time. Users may scan the QR code (URL type) through QR code scanner enabled Camera or any other QR Code scanner app at the exit gate.

Once a user scans the QR code and clicks the link, the default browser may open with a predefined URL and encrypted query string. If it's a cross browser then URL may open the Welcome page with input fields email and phone number otherwise Check-Out Screen may be open. If a user clicks the submit button on the welcome page, then also the Check-Out page may open.

The Check-Out screen may display the payment details along with check-in/out details. Once a user clicks the proceed to check-out button and payment is done, the ParkEngage server may verify the data and check if the vehicle is present at the exit gate, gate may open through ParkEngage cloud server, and the user may redirect to the thank you page.

Certain embodiments may utilize a Web URL Type QR Code. The steps for check in this embodiment may include the steps of a user entering into the parking. User may scan the QR code (URL type) through QR code scanner enabled Camera or any other QR Code scanner app at the entry gate.

Once a user scans the QR code and clicks the link, the default browser may open with a predefined URL and encrypted query string. URL may open the Welcome page with input fields email and phone number. Once the user enters the phone number and email and clicks the submit button, the user may redirect to the Check-In page details with prepaid booking details.

On the Check-In page user may click on the Proceed to Check-In button, ParkEngage server may verify the data and check if the vehicle is present at the exit gate, gate may open through ParkEngage cloud server, and the user may redirect to the Thank You page.

Similarly, for the check-out process the steps may include the following: user reaches the exit gate after some period of time. User scans the QR code (URL type) through QR code scanner enabled Camera or any other QR Code scanner app at the exit gate.

Once a user scans the QR code and clicks the link, the default browser may open with a predefined URL and encrypted query string. If it's a cross browser then URL may open the Welcome page with input fields email and phone number, otherwise Check-Out Screen with prepaid booking details may be open. If a user clicks the submit button on the welcome page, then also the Check-Out page with prepaid booking details may open.

Once a user clicks the proceed to check-out button, ParkEngage server may verify the data If there is any overstay amount pending, the user may redirect to the payment screen where it may show the balance or overstay amount. Once the server is verified the payment user may again redirect to the QR code scanner screen. If there is no overstay pending ParkEngage server may check if the vehicle is present at the exit gate, gate may open through ParkEngage cloud server, and the user may redirect to the thank you page

In case of overstay, once again, the user scans the QR code through a web page or screen, ParkEngage server may verify the data and check if the vehicle is present at the exit gate, gate may open through ParkEngage cloud server, and the user may redirect to the thank you page.

Alternatively, in yet another embodiment, the check-out process may be accomplished by using a weblink whereas the steps may include the following actions: user reaches the exit gate after some period of time. User clicking the check-out link received through email during check-in.

Once a user clicks the Check-out link user may redirect to the check-out screen with prepaid booking details. Once a user clicks the proceed to check-out button, ParkEngage server may verify the data If there is any overstay amount pending, the user may redirect to the payment screen where it may show the balance or overstay amount. Once the server is verified the payment user may again redirect to the QR code scanner screen. If there is no overstay pending ParkEngage server may check if the vehicle is present at the exit gate, gate may open through ParkEngage cloud server, and the user may redirect to the thank you page

Once again, the user scans the QR code through a web page or screen, ParkEngage server may verify the data and check if the vehicle is present at the exit gate, gate may open through ParkEngage cloud server, and the user may redirect to the thank you page.

The methods and systems discussed here include a cloud-based system accessible through the internet from an end user's mobile device (smart phone or tablet). The end user initiates entry into the parking facility, either by accessing their existing e-ticket (if they have a pre-paid reservation) or by using their smart device camera to scan a QR code at the entry to the facility (if they do not have an existing e-ticket for a pre-paid reservation).

When they have scanned the QR Code, this may initiate the check-in process to the facility and open the gate if it is a gated facility or notify the valet if it is a valet facility. If the end-user does not have an existing e-ticket for a pre-paid reservation, the system may create that e-ticket; in either case, a link to that e-ticket (pre-existing or newly created) may be sent to the end-user's device in an SMS text message for future access when paying or exiting. Each of these steps is described in detail below.

All of the functions of the cloud system may be initiated through an API call and so the functionality described below may be incorporated into a mobile app or other system or technology to initiate the behavior specified. Part of this invention is a mobile responsive website which provides a universal user interface to the end-user and this mobile responsive website also calls the cloud system's APIs to elicit the behavior described below.

Apparatus, methods and systems according to embodiments of the application are described. Although specific embodiments are illustrated and described herein, it may be appreciated by those of ordinary skill in the art that any arrangement which is calculated to achieve the same purposes may be substituted for the specific embodiments shown. This application is intended to cover any adaptations or variations of the embodiments and disclosure. For example, although described in terminology and terms common to the field of art, exemplary embodiments, systems, methods and apparatus described herein, one of ordinary skill in the art may appreciate that implementations may be made for other fields of art, systems, apparatus or methods that provide the required functions. The invention should therefore not be limited by the above-described embodiment, method, and examples, but by all embodiments and methods within the scope and spirit of the invention.

In particular, one of ordinary skill in the art will readily appreciate that the names of the methods and apparatus are not intended to limit embodiments or the disclosure. Furthermore, additional methods, steps, and apparatus can be added to the components, functions can be rearranged among the components, and new components to correspond to future enhancements and physical devices used in embodiments can be introduced without departing from the scope of embodiments and the disclosure. One of skill in the art will readily recognize that embodiments are applicable to future systems, future apparatus, future methods, and different materials.

All methods described herein can be performed in a suitable order unless otherwise indicated herein or otherwise clearly contradicted by context. The use of any and all examples, or exemplary language (e.g., “such as”), is intended merely to better illustrate the disclosure and does not pose a limitation on the scope of the disclosure unless otherwise claimed. No language in the specification should be construed as indicating any non-claimed element as essential to the practice of the disclosure as used herein.

Terminology used in the present disclosure is intended to include all environments and alternate technologies that provide the same functionality described herein.

We claim:

1. A computer-implemented system to control access by a subject vehicle to a secured vehicle parking facility, said system comprising:
a platform server comprising a processor;
platform application software executable by the processor of the platform server, the platform application software configured to control an access control gate to prevent a subject vehicle from exiting a secured vehicle parking facility at said access control gate unless an exit condition is satisfied, the exit condition comprising:
a determination that the subject vehicle is identical to an earlier entering vehicle in the secured vehicle parking facility,
receipt of an exit request for the subject vehicle to physically exit the secured vehicle parking facility through said access control gate, and
actual receipt of payment for a parking fee calculated for parking the subject vehicle during the period from entry of the earlier entering subject vehicle until said exit request; and
said platform server receiving said exit request via a local token comprising information obtained by touchless scanning of the subject vehicle's license plate along with information identifying the access control gate.

2. The computer-implemented system of claim 1, further comprising:
said platform server receiving confirmation of said actual receipt of payment via an automated communication from an electronic payment platform in relation to touchless initiation of electronic payment at one of, the time of the vehicle's entrance in the secured parking facility and the time of vehicle's exit from the secured parking facility.

3. The computer-implemented system of claim 1, further comprising:
said determination that the subject vehicle is identical to an earlier entering vehicle in the secured vehicle parking facility performed through an e-ticket created from the vehicle license plate scanned by a license plate reader camera at the time of vehicle's entry in the secured parking facility and validated by scanning the vehicle's license plate by a second license plate reader camera at the time of vehicle's exit from the secured vehicle parking facility.

4. The computer-implemented system of claim 1, further comprising:
a compact credit card payment device with a built-in camera to scan a QR code enabling touchless payments using one of, a credit card and a mobile phone and enabling validation using the QR code on a mobile device.

5. A computer-implemented method comprising:
configuring a platform application software executable by a processor of a platform server to control an access control gate to prevent a subject vehicle from exiting a secured vehicle parking facility at said access control gate unless an exit condition is satisfied, the exit condition comprising:
identifying to determine whether the subject vehicle is identical to an earlier entering vehicle in the secured vehicle parking facility,
receiving of an exit request for the subject vehicle to physically exit the secured vehicle parking facility through said access control gate, and
actual receiving of payment for a parking fee calculated for parking the subject vehicle during the period from entry of the earlier entering subject vehicle until said exit request;
operating a touchless vehicle detection system by reading the vehicle's license plate by a license plate reader camera to determine identity of the subject vehicle in relation to an earlier entering vehicle in the secured vehicle parking facility; and
executing said exit request to open said access control gate.

6. A non-transitory computer-readable medium having tangibly embodied thereon and accessible therefrom processor-executable instructions that, when executed by at least one data processing device of a data processing system, causes said at least one data processing device to perform a method comprising:
configuring platform application software executable by the processor of a platform server to control an access control gate to prevent a subject vehicle from exiting a secured vehicle parking facility at said access control gate unless an exit condition is satisfied, the exit condition comprising:
identity of the subject vehicle is identical to an earlier entering vehicle in the secured vehicle parking facility,
receipt of an exit request for the subject vehicle to physically exit the secured vehicle parking facility through said access control gate, and
actual receipt of payment for a parking fee calculated for parking the subject vehicle during the period from entry of the earlier entering subject vehicle until said exit request;
operating a license plate reader camera at said access control gate to read the vehicle's license plate to present an exit request for the subject vehicle to physically exit a secured vehicle parking facility through said access control gate; and
operating a touchless vehicle detection system to determine identity of the subject vehicle in relation to an earlier entering vehicle in the secured vehicle parking facility.

7. A computer-implemented system comprising:
a platform server comprising a processor;
a platform application software executable by the processor of the platform server, the platform application software configured to control an access control gate to control a subject vehicle access to a secured vehicle parking facility at said access control gate and to preregister a user with user's mobile device, credit card and vehicle license plate information;
said platform server receiving an entry request via an automated message initiated by touchless scanning of a license plate to identify said vehicle, by operation of a license plate reader camera installed at the said access control gate;
said platform server creating a virtual link between said subject vehicle license plate and said access control gate;
said platform server sending a payment link to said user's registered mobile device; and
a receipt of a payment by said platform server, said payment initiated through the use of said payment link.

8. The computer implemented system of claim 7, further comprising:
said platform server receiving an exit request via a second automated message initiated by touchless scanning of said vehicle's license plate for the subject vehicle to physically exit the secured vehicle parking facility through said access control gate after said receipt of said payment.

9. The computer-implemented method of claim 7, further comprising:
the step of:
sending a receipt of the said payment to the said user through electronic means.

10. The computer-implemented method of claim 7, further comprising:
the step of:
allowing the user to provide a promotional code for discounted payment amount prior to sending the payment link to said user's registered mobile device.
